(19) United States
(12) Patent Application Publication
(10) Pub. No.: US 2022/0239645 A1
(43) Pub. Date: Jul. 28, 2022

(54) Method of separating and authenticating terminal equipment

(71) Applicant: Chih-Fu Hwang, Taipei (TW)

(72) Inventor: Chih-Fu Hwang, Taipei (TW)

(21) Appl. No.: 17/385,093

(22) Filed: Jul. 26, 2021

(30) Foreign Application Priority Data
Jan. 22, 2021 (TW) 110102552

(51) Int. Cl. H04L 29/06; H04L 29/12

(52) U.S. Cl. CPC H04L 63/0876; H04L 61/103; H04L 63/101

(57) ABSTRACT

A method of separating and authenticating terminal equipment includes using a control mechanism of the QA over the Intranet to activate the IU in the MIG to check, and monitor and determine the equipment safety level of the TL in the QA without an installation of the updated version of operating system and the antivirus software. It prevents installed malicious software from connecting to the Internet and the Intranet. Otherwise, an abnormal data access may be performed to compromise the safety of the system.

### BACKGROUND OF THE INVENTION

### 1. Field of the Invention

The invention relates to a method of separating and authenticating terminal equipment and more particularly to a method of separating and authenticating terminal equipment by providing control and separation over a local area network (LAN).

### 2. Description of Related Art

RADIUS (Remote Authentication Dial-In User Service) is often the back-end of choice for 802.1X authentication. A RADIUS server employs an MAC (media access control) address to authenticate data input. However, the method does not provide control and separation over the LAN to check, monitor and authenticate safety of data transferred to a unit of terminal equipment. Thus, the unit of terminal equipment may be damaged or even compromises the data if a computer operating system is not updated in time, antivirus software is not updated in time, a computer virus is maliciously installed in the software of the unit of terminal equipment, or the unit of terminal equipment being directed connected to the Internet without running a protection program.

Thus, the need for improvement still exists.

### SUMMARY OF THE INVENTION

It is therefore one object of the invention to provide a method for operating a network terminal equipment separation system for 802.1X authentication, the network terminal equipment separation system for 802.1X authentication including a plurality of units of terminal equipment (TL), a network switch (SW), a master server (MS), an authentication server (RS), an update server (US) and an MAC address information gathering device (MIG) wherein the units of TL, the MS, the RS, the US and the MIG are respectively connected to the SW over the Internet, thereby forming a local area network (LAN); data communications are carried out over the LAN using Address Resolution Protocol (ARP), a plurality of virtual LANs and a control and separation based virtual LAN (QA) created by configuring a dynamic virtual LAN in the Intranet; the MIG includes a scanning unit (SU), a data collecting unit (CU), a data output unit (OU), and an inspection unit (IU); and the US is provided in the QA, the method comprising the steps of using the SU to scan a plurality of ARP packets transmitted from the units of TL wherein an IP address and an MAC address associated with a predetermined unit of TL are obtained by decoding the ARP packets' raw data, and the SU stores both the IP address and the MAC address in a terminal equipment address scanning record stored in the CU; authorizing a system manager to access the CU over the LAN and the terminal equipment address scanning record in the CU, and check the MAC address associated with the predetermined unit of TL over the LAN so that the system manager is capable of determining whether the MAC address is an authorized MAC address or not wherein the system manager is capable of assigning an unauthorized MAC address in the terminal equipment address scanning record as an authorized MAC address, deleting either the unauthorized MAC address in the terminal equipment address scanning record or the authorized MAC address in the terminal equipment address scanning record, saving an updated terminal equipment address scanning record as a terminal equipment record authorization MAC address list, storing the terminal equipment record authorization MAC address list in the OU, and deleting the an Internet Protocol (IP) address associated with the deleted MAC address; authorizing the MIG to access the RS over the LAN wherein the MIG stores the terminal equipment record authorization MAC address list as a data transfer record authorization MAC address list in the RS, data in the RS is updated in real time, the RS is connected to the OU over the LAN, and the terminal equipment record authorization MAC address list in the OU is accessed and stored as a data transfer record authorization MAC address list in the RS to update data in the RS in real time; authorizing the RS to determine whether the MAC address associated with the predetermined unit of TL is the authorized MAC address or not based on the data transfer record authorization MAC address list and further determine the right of transferring data over the LAN by the predetermined unit of TL wherein the RS is capable of rejecting or blocking the predetermined unit of TL associated with the unauthorized MAC address from accessing data or transferring data over the Intranet; if the MAC address of the predetermined unit of TL connected to the Internet is determined to be the authorized MAC address by the RS, authorizing the RS to assign the predetermined unit of TL to the QA via the SW wherein the predetermined unit of TL in the QA is not connected to the Intranet; connecting the IU to the predetermined unit of TL in the QA over the Internet wherein data communications are carried out to confirm versions of both an operating system of the predetermined unit of TL and antivirus software, and the predetermined unit of TL is monitored continuously to determine whether data access is performed over the Intranet or not; if the IU in the MIG determines that the predetermined unit of TL in the QA has the updated versions of both the operating system and the antivirus software and there is no abnormal data access, authorizing the IU to determine that an equipment safety level of the predetermined unit of TL in the QA is safe and inform same to the RS, and authorizing the RS to request the predetermined unit of TL to apply for authentication to the RS; after the predetermined unit of TL in the QA has applied for authentication to the RS, authorizing the RS to reset the SW based on an embedded system registration MAC address connecting a virtual LAN configuration list so that the predetermined unit of TL is capable of connecting to the MAC address of the predetermined unit of TL over the Internet, and the predetermined unit of TL is capable of transferring data over the virtual LAN and the Intranet corresponding to the MAC address of the predetermined unit of TL; if the IU in the MIG determines that the predetermined unit of TL in the QA does not have the updated versions of both the operating system and the antivirus software, authorizing the IU to request the predetermined unit of TL to update versions of both the operating system and the antivirus software wherein after the predetermined unit of TL has connected to the US in the QA and the updated versions of both the operating system and the antivirus software are installed in the predetermined unit of TL, the update is completed; if the IU in the MIG determines that the predetermined unit of TL in the QA has finished the update and there is no abnormal data access, authorizing the IU in the MIG to determine that the equipment safety level of the predetermined unit of TL in the QA is safe and inform same to the RS, and authorizing the RS to request the predetermined unit of TL to apply for authentication to the RS; after the predetermined unit of TL in the QA has applied for authentication to the RS, the RS has reset the SW based on the embedded system registration MAC address connecting the virtual LAN configuration list, connecting the predetermined unit of TL to the MAC address of the predetermined unit of TL over the Internet so that the predetermined unit of TL is capable of transferring data over the virtual LAN and the Intranet corresponding to the MAC address of the predetermined unit of TL; and if the IU in the MIG determines that the predetermined unit of TL in the QA has the updated versions of both the operating system and the antivirus software and there is abnormal data access, authorizing the IU to determine that the equipment safety level of the predetermined unit of TL in the QA is in a continuous separation state and inform same to the RS, and authorizing the RS to inform the system manager of a warning message by connecting to the MS over the Internet so that the system manager controls the MS to disconnect the predetermined unit of TL in the QA from the Internet, thereby preventing the system from being damaged due to both the Internet and the Intranet connections or abnormal data access.

The above and other objects, features and advantages of the invention will become apparent from the following detailed description taken with the accompanying drawings.

### BRIEF DESCRIPTION OF THE DRAWINGS

FIG. 1 is a block diagram of a system of the invention.

### DETAILED DESCRIPTION OF THE INVENTION

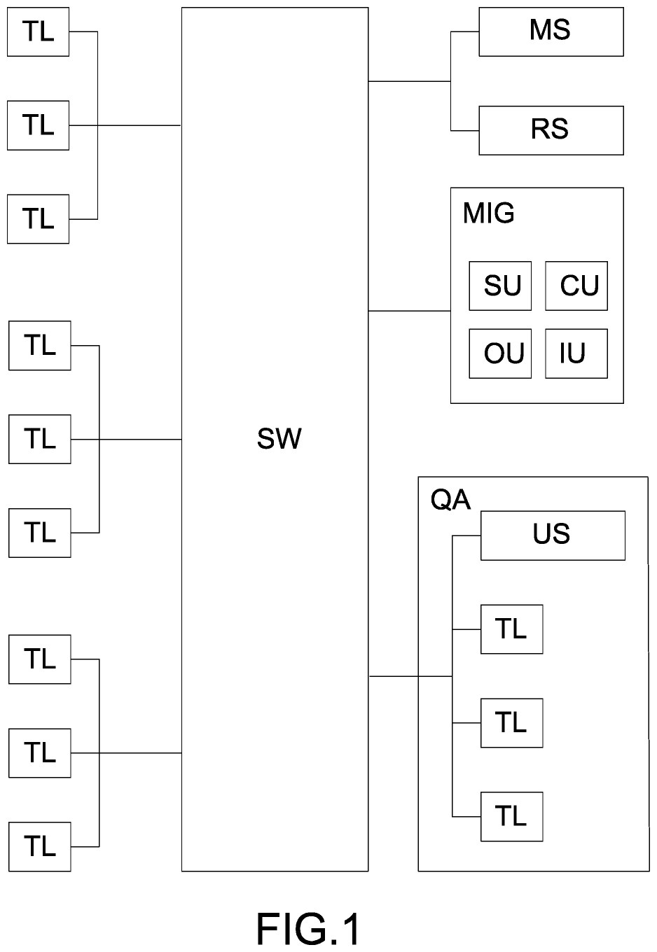

Referring to FIG. 1, it is a block diagram of a system of the invention tied to a method of separating and authenticating terminal equipment according to a preferred embodiment of the invention. The system is implemented as a network terminal equipment separation system for 802.1X authentication.

The network terminal equipment separation system for 802.1X authentication comprises a plurality of units of terminal equipment (TL), a network switch (SW), a master server (MS), an authentication server (RS), an update server (US) and an MAC address information gathering device (MIG). The units of TL, the MS, the RS, the US and the MIG are respectively connected to the SW over the Internet, thereby forming a local area network (LAN). Data communications are carried out over the LAN using Address Resolution Protocol (ARP). A plurality of virtual LANs and a control and separation based virtual LAN (QA) are created by configuring a dynamic virtual LAN in the Intranet. The MIG includes a scanning unit (SU), a data collecting unit (CU), a data output unit (OU) and an inspection unit (IU). The US is provided in the QA.

The method of separating and authenticating terminal equipment comprises the steps of:

The SU is used to scan a plurality of ARP packets transmitted from the units of TL. IP address and MAC address associated with a predetermined TL are obtained by decoding the packet's raw data. Then the SU stores the IP (Internet Protocol) address and the MAC address in a terminal equipment address scanning record which is in turn stored in the CU.

A system manager can access the CU over the LAN. Next, the system manager can access the terminal equipment address scanning record in the CU and check the MAC address associated with a predetermined TL over the LAN. Thus, the system manager can determine whether the MAC address is an authorized MAC address. The system manager can assign the unauthorized MAC address in the terminal equipment address scanning record as an authorized MAC address, delete the unauthorized MAC address in the terminal equipment address scanning record, or delete the authorized MAC address in the terminal equipment address scanning record. Next, the system manager can save the updated terminal equipment address scanning record as a terminal equipment record authorization MAC address list and store same in the OU. The IP address associated with the deleted MAC address is also deleted.

The MIG can access the RS over the LAN. The MIG next stores the terminal equipment record authorization MAC address list as a data transfer record authorization MAC address list which is in turn stored in the RS. Thus, data in the RS is updated in real time.

Alternatively, the RS is connected to the OU over the LAN, and the terminal equipment record authorization MAC address list stored in the OU is accessed and stored as a data transfer record authorization MAC address list in the RS to update data in the RS in real time;

The RS can determine whether the MAC address associated with the TL is the authorized MAC address based on the data transfer record authorization MAC address list and further determine the right of transferring data over the LAN by the TL. The RS can reject or block the TL associated with the unauthorized MAC address from accessing data or transferring data over the Intranet. If the MAC address of a predetermined TL connected to the Internet is determined to be an authorized MAC address by the RS, the RS assigns the TL to the QA via a port of the SW. The TL in the QA is not allowed to connect to the Intranet for data communications.

The IU is connected to the TL in the QA over the Internet. Data communications are thus carried out to confirm version of the operating system of the TL and version of the antivirus software. The TL is monitored continuously to determine whether data access is performed over the Intranet. If the IU in the MIG determines that the TL in the QA has the latest updated versions of the operating system and the antivirus software and there is no abnormal data access, the IU then determines that the equipment safety level of the TL in the QA is safe and informs same to the RS. And in turn, the RS requests the TL to apply for authentication to the RS. After the TL in the QA has applied for authentication to the RS, the RS has reset the port of the SW based on the embedded system registration MAC address connection virtual LAN configuration list. Thus, the TL can be connected to the MAC address of the TL over the Internet. And in turn, the TL can transfer data over the virtual LAN and the Intranet corresponding to the MAC address of the TL.

If the IU in the MIG determines that the TL in the QA does not have the latest updated versions of the operating system and the antivirus software. The IU then requests the TL to update the operating system and the antivirus software to their latest versions. After the TL has connected to the US in the QA and the latest versions of the operating system and the antivirus software are installed in the TL. This completes the update.

If the IU in the MIG determines that the TL in the QA has finished the update and there is no abnormal data access, the IU in the MIG determines that the equipment safety level of the TL in the QA is safe and informs same to the RS. And in turn, the RS requests the TL to apply for authentication to the RS.

After the TL in the QA has applied for authentication to the RS, the RS has reset the port of the SW based on the embedded system registration MAC address connection virtual LAN configuration list. Thus, the TL can be connected to the MAC address of the TL over the Internet. And in turn, the TL can transfer data over the virtual LAN and the Intranet corresponding to the MAC address of the TL.

If the IU in the MIG determines that the TL in the QA has the latest updated versions of the operating system and the antivirus software and there is abnormal data access, the IU then determines that the equipment safety level of the TL in the QA is in the continuous separation state and informs same to the RS. And in turn, the RS then informs a system manager of a warning message by connecting to the MS over the Internet. The system manager then controls the MS to disconnect the TL in the QA from the Internet or directly plugs off the Internet cable. This can prevent the system from being damaged due to the Internet and the Intranet connections or abnormal data access.

It is envisaged by the invention that the method involves using a control mechanism of the QA over the Intranet to activate the IU in the MIG to check, monitor and determine the equipment safety level of the TL in the QA so as to prevent the TL without the installation of the latest updated versions of the operating system and the antivirus software or having the installation of the malicious software from being connected to the Internet and the Intranet. Otherwise, an abnormal data access may be performed to compromise the safety of the system.

It is also envisaged by the invention that the method involves using the content of the ARP packets of the MIG transmitted over the Internet to obtain IP address and MAC address associated with a predetermined TL so that the system manager can check, set or modify file data and update data in the RS, the RS can reject and block unauthorized connection to the LAN for accessing data or transferring data.

It is further envisaged by the invention that the method eliminates conventional manual check, verification and determination of MAC address of a terminal equipment and manual creation of MAC address list both being time consuming and error prone. It is further envisaged by the invention that the method can record IP address or host name in data of an automatically created file, enable a system manager to authenticate whether a unit of terminal equipment is an authorized unit of terminal equipment. This is a contrast to the conventional method of authenticating a unit of terminal equipment by a host by verifying inputted username and password. As a result, information safety of the Intranet is greatly increased.

While the invention has been described in terms of preferred embodiments, those skilled in the art will recognize that the invention can be practiced with modifications within the spirit and scope of the appended claims.

What is claimed is:

1. A method for operating a network terminal equipment separation system for 802.1X authentication, the network terminal equipment separation system for 802.1X authentication including a plurality of units of terminal equipment (TL), a network switch (SW), a master server (MS), an authentication server (RS), an update server (US) and an MAC address information gathering device (MIG) wherein the units of TL, the MS, the RS, the US and the MIG are respectively connected to the SW over the Internet, thereby forming a local area network (LAN); data communications are carried out over the LAN using Address Resolution Protocol (ARP), a plurality of virtual LANs and a control and separation based virtual LAN (QA) created by configuring a dynamic virtual LAN in the Intranet; the MIG includes a scanning unit (SU), a data collecting unit (CU), a data output unit (OU), and an inspection unit (IU); and the US is provided in the QA, the method comprising the steps of:
using the SU to scan a plurality of ARP packets transmitted from the units of TL wherein an IP address and an MAC address associated with a predetermined unit of TL are obtained by decoding the ARP packets' raw data, and the SU stores both the IP address and the MAC address in a terminal equipment address scanning record stored in the CU;
authorizing a system manager to access the CU over the LAN and the terminal equipment address scanning record in the CU, and check the MAC address associated with the predetermined unit of TL over the LAN so that the system manager is capable of determining whether the MAC address is an authorized MAC address or not wherein the system manager is capable of assigning an unauthorized MAC address in the terminal equipment address scanning record as an authorized MAC address, deleting either the unauthorized MAC address in the terminal equipment address scanning record or the authorized MAC address in the terminal equipment address scanning record, saving an updated terminal equipment address scanning record as a terminal equipment record authorization MAC address list, storing the terminal equipment record authorization MAC address list in the OU, and deleting the an Internet Protocol (IP) address associated with the deleted MAC address;
authorizing the MIG to access the RS over the LAN wherein the MIG stores the terminal equipment record authorization MAC address list as a data transfer record authorization MAC address list in the RS, data in the RS is updated in real time, the RS is connected to the OU over the LAN, and the terminal equipment record authorization MAC address list in the OU is accessed and stored as a data transfer record authorization MAC address list in the RS to update data in the RS in real time;
authorizing the RS to determine whether the MAC address associated with the predetermined unit of TL is the authorized MAC address or not based on the data transfer record authorization MAC address list and further determine the right of transferring data over the LAN by the predetermined unit of TL wherein the RS is capable of rejecting or blocking the predetermined unit of TL associated with the unauthorized MAC address from accessing data or transferring data over the Intranet;
if the MAC address of the predetermined unit of TL connected to the Internet is determined to be the authorized MAC address by the RS, authorizing the RS to assign the predetermined unit of TL to the QA via the SW wherein the predetermined unit of TL in the QA is not connected to the Intranet;
connecting the IU to the predetermined unit of TL in the QA over the Internet wherein data communications are carried out to confirm versions of both an operating system of the predetermined unit of TL and antivirus software, and the predetermined unit of TL is monitored continuously to determine whether data access is performed over the Intranet or not;
if the IU in the MIG determines that the predetermined unit of TL in the QA has the updated versions of both the operating system and the antivirus software and there is no abnormal data access, authorizing the IU to determine that an equipment safety level of the predetermined unit of TL in the QA is safe and inform same to the RS, and authorizing the RS to request the predetermined unit of TL to apply for authentication to the RS;
after the predetermined unit of TL in the QA has applied for authentication to the RS, authorizing the RS to reset the SW based on an embedded system registration MAC address connecting a virtual LAN configuration list so that the predetermined unit of TL is capable of connecting to the MAC address of the predetermined unit of TL over the Internet, and the predetermined unit of TL is capable of transferring data over the virtual LAN and the Intranet corresponding to the MAC address of the predetermined unit of TL;
if the IU in the MIG determines that the predetermined unit of TL in the QA does not have the updated versions of both the operating system and the antivirus software, authorizing the IU to request the predetermined unit of TL to update versions of both the operating system and the antivirus software wherein after the predetermined unit of TL has connected to the US in the QA and the updated versions of both the operating system and the antivirus software are installed in the predetermined unit of TL, the update is completed;
if the IU in the MIG determines that the predetermined unit of TL in the QA has finished the update and there is no abnormal data access, authorizing the IU in the MIG to determine that the equipment safety level of the predetermined unit of TL in the QA is safe and inform same to the RS, and authorizing the RS to request the predetermined unit of TL to apply for authentication to the RS;
after the predetermined unit of TL in the QA has applied for authentication to the RS, the RS has reset the SW based on the embedded system registration MAC address connecting the virtual LAN configuration list, connecting the predetermined unit of TL to the MAC address of the predetermined unit of TL over the Internet so that the predetermined unit of TL is capable of transferring data over the virtual LAN and the Intranet corresponding to the MAC address of the predetermined unit of TL; and
if the IU in the MIG determines that the predetermined unit of TL in the QA has the updated versions of both the operating system and the antivirus software and there is abnormal data access, authorizing the IU to determine that the equipment safety level of the predetermined unit of TL in the QA is in a continuous separation state and inform same to the RS, and authorizing the RS to inform the system manager of a warning message by connecting to the MS over the Internet so that the system manager controls the MS to disconnect the predetermined unit of TL in the QA from the Internet, thereby preventing the system from being damaged due to both the Internet and the Intranet connections or abnormal data access.
